(19) United States
(12) Patent Application Publication
(10) Pub. No.: US 2026/0180828 A1
(43) Pub. Date: Jun. 25, 2026

(54) DISRUPTING A REMOTELY CONTROLLED AERIAL VEHICLE

(71) Applicant: D-FEND SOLUTIONS AD LTD., RAANANA (IL)

(72) Inventors: Hanan LEIZEROVICH, Petah Tikva (IL); Nadav Arie, Tel Aviv (IL); Assaf Monsa Chermon, Kfar Yedida (IL); Yaron Bebes, Petech Tikva (IL)

(73) Assignee: D-FEND SOLUTIONS AD LTD., RAANANA (IL)

(21) Appl. No.: 19/126,639

(22) PCT Filed: Nov. 2, 2023
(86) PCT No.: PCT/IB2023/061077

§ 371 Date: May 1, 2025

(30) Foreign Application Priority Data
Nov. 2, 2022 (IL) 297894

(51) Int. Cl. H04L 12/66; H04J 3/06; H04L 69/16; H04L 69/163

(52) U.S. Cl. CPC H04L 12/66; H04J 3/0667; H04L 69/16; H04L 69/163

(57) ABSTRACT

A computerized method for disrupting a time division multiplex communication between a target remotely-controlled aerial vehicle related communication unit (RCU) and another RCU. The method may include determining a timing of a transmission, by a disruptive entity, of a disruptive signal aimed to the target RCU based on (a) a distance (Dto(t)) between the target RCU and the other RCU, and (b) at least one of (i) a distance (Ddt(t)) between the disruptive entity and the target RCU, or (ii) a distance (Ddo(t)) between the disruptive entity and the other RCU; and transmitting the disruptive signal to the target RCU according to the timing of the transmission

### BACKGROUND

A remotely controlled aerial vehicle (RCAV) may be controlled by a remote controller. The RCAV may transmit information during an RCAV time window that may be followed (or preceded) by a remote controller time window.

There is a growing need to provide an efficient method for RCAV disruption.

### SUMMARY

There may be provided systems, methods, and computer readable medium as illustrated in the specification.

### BRIEF DESCRIPTION OF THE DRAWINGS

The embodiments of the disclosure will be understood and appreciated more fully from the following detailed description, taken in conjunction with the drawings in which:

FIGS. 1-2 illustrate an example of a method;

FIG. 3 illustrates an example of a method;

FIG. 4 illustrates an example of a target remotely-controlled aerial vehicle related communication unit (RCU) and another RCU;

FIG. 5 illustrates an example of a target RCU and another RCU; and

FIG. 6 illustrates example of one or more timing diagrams.

### DESCRIPTION OF EXAMPLE EMBODIMENTS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a device or system capable of executing the method and/or to a non-transitory computer readable medium that stores instructions for executing the method.

Any reference in the specification to a system or device should be applied mutatis mutandis to a method that may be executed by the system, and/or may be applied mutatis mutandis to non-transitory computer readable medium that stores instructions executable by the system.

Any reference in the specification to a non-transitory computer readable medium should be applied mutatis mutandis to a device or system capable of executing instructions stored in the non-transitory computer readable medium and/or may be applied mutatis mutandis to a method for executing the instructions.

Any combination of any module or unit listed in any of the figures, any part of the specification and/or any claims may be provided.

The specification and/or drawings may refer to a processor. The processor may be a processing circuitry. The processing circuitry may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits.

Any combination of any steps of any method illustrated in the specification and/or drawings may be provided.

Any combination of any subject matter of any of claims may be provided.

Any combinations of systems, units, components, processors, sensors, illustrated in the specification and/or drawings may be provided.

There may be provided a method, a system, and a computer readable medium for RCAV disruption.

Any reference to “disruption” may be applied mutatis mutandis to “mitigation”.

A RCAV may be programmed and/or otherwise configured to complete a task and/or a mission. This may include arriving to a destination and/or performing an operation when arriving to the destination. A RCAV may also be regarded as arriving to the destination when the destination is in reach of the RCAV. The destination is in reach of the RCAV when the RCAV is positioned at a location that enables the RCAV to complete the task related to the destination. The operation may include the photography of a target, exploding a target associated with the destination, delivering a payload (that may or may not be a damaging payload) to the target, performing an electronic countermeasure, acquiring information regarding the target, directing accurate ammunition to the target, and the like. The mitigation of the RCAV may include preventing the RCAV to complete his task and/or mission.

When referring to a “remote controller”, this includes, besides a remote controller device, any other controlling device like a ground station, Virtual Reality goggles, smartphone or tablet, control stick, telemetry module, secondary remote controller (e.g. gimbal controller), smart controllers (controllers that include a screen and are sometimes programmable), and the like.

A RCAV may communicate, using a RCAV communication unit, with one or more other devices such as a remote controller that has its own communication unit. The RCAV communication unit and any communication unit that communicates with the RCAV communication unit are referred to as a RCAV related communication unit. A RCAV related communication unit is a communication unit that participated in a communication between a RCAV and one or more other devices.

Time division multiplexing communication is a common channel access, meaning that each party in the communication has a time slot that it is expected or allowed to transmit, and other time slots where it expects to receive, or indeed receives, transmissions made by other parties. It is typical or possible for a node active in such communication to only respond to packets that are received from other parties to the communication in their allotted time slots, and ignore packets that are received in unexpected timing (assuming practically that since they were not received in the expected timing, they were not sent by the corresponding node), even if the channel is quiet enough to allow for their processing. In some scenarios (e.g. communication between a RCAV and its remote controller), the communication may be done over a significant distance (for instance, a few kilometers), and there is a delay between the time of transmission by one node and the time of reception by another node. Considering the speed of propagation of the signal (in RF communication it is the speed of light), this delay can be in the order of magnitude of a few microseconds for a distance of a few kilometers.

Typical ways to allow for this delay so that each node would still accept the packets received by other nodes despite this delay are:
Allowing for a time tolerance of a few microseconds to allow for the packets to be received within that time tolerance regardless of the distance, within the relevant distance for the communication
Changing the timing of the transmission according to the distance so that the farther away the nodes are from each other, the earlier the packets would be transmitted, and hence the packets would be received in the expected timing: this would understandably work when there are only two nodes to the communication as the delay would be different between two receiving nodes if their distance from the transmitting node is not equal.
Dynamically gauging the window of time a node expects to receive packets from another node according to past packets already received. After allowing for a larger time tolerance, and accepting a number of packets within this tolerance, this gauging can allow for a smaller time tolerance. Alternatively, if the distance between the transmitting node and the receiving node is known to the nodes, the time tolerance can be maintained small as the expected time window can be pre-calculated using that distance.

Either of these processes may be synchronized between the nodes, or it can be managed by one of the nodes, functioning as the master for this process.

It is important to note that in some cases, one of the nodes is functioning as a master for the communication, and the other nodes would respond to that master in a way that their transmission would be in a fixed delay after their reception of the communication from the master, and their time tolerance for reception of communication from the master node would be infinite (meaning-they will accept any communication from the master regardless of its timing). Thus, they will only send a packet in response to a packet received from the master, they will accept any packet received from the master and will respond with their own packet sent to the master, transmitting it at a fixed timing after the receipt of the packet from the master node. The master will expect the response packet to be received considering the delay caused by the distance between it and the other node (both to and from that node), plus the fixed delay, and will be able to thus narrow the time tolerance for such reception. This method would understandably work best when all communication in the channel is done between the master and one of the nodes (a star shaped communication) or when there are only two parties to the communication (master and slave). Additionally, the master can also include in its communication the time delay it requests the slave to wait before sending its response. This gives the master the control of timing and negates the need for the slave to do any distance-related processing.

All this gets complicated when the parties can move during the communication. For simplicity's sake, the discussion below would be focused on two way communication.

When there is a two way time division multiplexing communication between two entities which are potentially mobile (e.g. RCVA in flight, remote controller held by a RCVA pilot who moves), the expectation each node has of the timing of receipt of a communication packet from the other node needs to take such potential movement into account. Assuming the movement is not extremely fast (e.g. in the scale of up to a few 10s of meters/second), and that the time difference between two consecutive communication packets is not extremely long (e.g. in the scale of up to a few 10s of milliseconds), the effect of such movement on such expected timing between consecutive packets is not very meaningful. However, the effect of the relocation of a node can accumulate over time. Ignoring the effect of relocation would create a shift between the expected timing for reception and the actual timing of reception in such a way that the packet may be rejected. Hence, it is imperative for the communication protocol to allow for an adaptation or modification of the expected timing, or for a large enough time tolerance in the expected reception time. It is relatively straightforward for a node to accept a packet of communication coming from the other moving node, as it would be received within a very small window of time around the expected timing. It can then dynamically adapt this expectation as the nodes move. As mentioned above, also the option of changing the timing of transmission by a slave node can be adapted according to the movement, and can be controlled by the master as part of the communication between the master and slave. In case both nodes are aware of their GPS location, they can alternatively calculate the expected timing of reception using the distance and the speed of propagation in order to create this timing.

Either way, the response inbred in the communication protocol to the fact that the nodes are potentially (or typically) on the move will also affect any third party which tries to actively intervene or interrupt this communication, or is otherwise sensitive to the expected timing of the communication. Not only that it needs to take into account the time it would take any transmission it transmits to reach the node it wishes to influence, which depends on the distance to that node, it also needs to adapt its timing if this distance changes because of its or that node's movement, and it needs to adapt its timing according to the expected timing of reception of communication from the other node, which as explained above can be influenced by the movement of the two nodes in the communication.

Resulting from all of the above is that in essence, in order for a system that might be on the move to intervene or interrupt a communication between a RCAV (or any other type of remotely controlled vehicle or device; RCAV will be used as an example henceforth) and its remote controller (or any other type of communication between nodes that at least one of them can be on the move), it needs to take into account:
The distance between it and the node it wishes to affect (typically the RCAV)
The distance between the remote controller and the RCAV
The method through which the communication protocol between the RCAV and the remote controller handles the change in propagation delay caused by the relocation of the RCAV and the remote controller
In some cases, also the speed of movement of either of the parties-the system, the RCAV, the remote controller
The accuracy and persistency of its knowledge of the location of the RCAV and the remote controller

As the communication packets needed for such interruption may take as little as a few microseconds, and the effect of all the factors mentioned above may be of the same order of magnitude, failing to take all these factors into account in a proper and accurate manner will probably cause such an interruption to fail or be severely flawed.

The discussion below will refer to the following scenarios:
The location of all three parties involved is accurately known.
The location of the intervening system is accurately known, and the location of the RCAV or the remote controller or both was known for a period of time and is not accurately known for some time
The location of the system is accurately known, and the location of the RCAV or the location of the remote controller are unknown.

All these scenarios assume that there is a knowledge of the communication protocol and its dynamic adaptation—if it exists—to the relocation of its nodes. In case the adaptation is not known, the method of intervening or interruption may cycle between the possible options until it successfully affects the communication.

For the purpose of the examples, a fixed duty cycle will be used, but similar considerations can be made if the duty cycle is not fixed. The duty cycle used for these example will be of 20 ms, wherein the RCAV is transmitting for 15 ms, and the remote controller is transmitting for 3 ms, and the rest of the cycle is silent (none of the nodes is transmitting). Exact timing of transmission within this cycle will depend on the protocol.

In case we know the accurate location of the parties, we can also compute the Euclidean distance between the parties. We will denote the distance between the system and the RCAV as Dₛᵤ, the distance between the remote controller and the RCAV as Dᵣᵤ, and the distance between the system and the remote controller as Dₛᵣ. We will also denote the speed of propagation of the transmitted signals as C.

As described above, the communication protocol may dictate several types of expectations that the RCAV may have for the receipt of a communication packet from its remote controller. We will focus on some of them. In each of them there will usually also be a tolerance T, meaning that a packet that was received within a time window of plus/minus of that T from the expected timing will be accepted, and a packet that was received outside of the window of plus/minus of that T from the expected timing will be rejected.

The method of setting of the expected timing can be for example as follows (a) A fixed gap from the beginning or ending of the transmission of the packet from the RCAV to the transmission of response from the remote controller, or (b) A fixed gap from the beginning or ending of the reception of the packet from the RCAV to the transmission of response from the remote controller.

A fixed gap from the beginning or ending of the transmission of the packet from the RCAV to the transmission of response from the remote controller.

The RCAV may expect to receive, regardless of the distance from the remote controller, the communication packet from the remote controller exactly 1 ms after the RCAV has completed its transmission, and it will begin its transmission exactly 1 ms after the end of the reception of the packet from the remote controller. Thus, the RCAV will transmit for 15 ms time, which will be followed by 1 ms of silence, then 3 ms of receipt of transmission from the remote controller, then 1 ms of silence, then it will start to transmit again.

For a duty cycle that starts in time to the RCAV will transmit between t₀ and t₀+15 ms, will expect silence between t₀+15 ms and t₀+16 ms, and then will expect to receive the transmission from the remote controller exactly between t₀+16 ms and t₀+19 ms. It will start transmitting its next packet on t₀+20 ms. In order for this to happen, the remote controller will need to transmit its packet at a timing that will match this expectation.

Taking into consideration the propagation delay, the remote controller will receive the packet from the RCAV only Dᵣᵤ/C seconds after the RCAV has started its transmission. The RCAV will hence expect to receive the packet from the remote controller 1 ms−Dᵣᵤ/C after the remote controller has received the end of transmission from the RCAV. The RCAV will also receive the packet that the remote controller has transmitted Dᵣᵤ/C seconds after the remote controller has started its transmission.

Hence, for the packet to be received by the RCAV 1 ms after it has ended its transmission, the remote controller will have to start transmitting it 1 ms−Dᵣᵤ/C after the RCAV has ended its transmission which is 1 ms−2×Dᵣᵤ/C after the remote controller has received the end of transmission from the RCAV.

Hence, the remote controller will experience a duty cycle which is different than what the RCAV will experience: it will receive the transmission from the RCAV between t₀+Dᵣᵤ/C and t₀+15 ms+Dᵣᵤ/C, then silence for 1 ms−2×Dᵣᵤ/C, then it will transmit for 3 ms between t₀+16 ms−Dᵣᵤ/C and t₀+19 ms−Dᵣᵤ/C, then silence again for 1 ms+2×Dᵣᵤ/C between t₀+19 ms−Dᵣᵤ/C and t₀+20ms+Dᵣᵤ/C until it starts receiving the next packet from the RCAV. The silence period that the remote controller is experiencing is shorter between the RCAV packet and the remote controller packet and longer between the remote controller packet and the next RCAV packet compared to the silence periods the RCAV is experiencing.

As the RCAV and the remote controller may constantly move, the distance Dᵣᵤmay change all the time (Dᵣᵤ(t) will denote the distance in time t, and the propagation time will be Dᵣᵤ(t)/C accordingly), and the remote controller will have to adjust the delay in the transmission of its packet after it has received the end of the transmission from the RCAV accordingly. Since Dᵣᵤ is typically measured in kilometers and C is the atmosphere speed of light, Dᵣᵤ/C will be measured in us (approximately 3 μs/km) and the delay the remote controller will have to use will be approximately 6 μs per kilometer of distance between the RCAV and the remote controller. The tolerance T will typically also be in the order of magnitude of a few μs. This explains the importance of the adjustment of the timing of transmission according to the distance Dᵣᵤ(t).

A fixed gap from the beginning or ending of the reception of the packet from the RCAV to the transmission of response from the remote controller.

The RCAV may expect the remote controller to transmit, regardless of the distance from the RCVA, the communication packet from the remote controller exactly 1 ms after the reception of the packet sent from the RCAV was completed, and it will begin its transmission after the end of the reception of the packet from the remote controller with a delay that will maintain the duty cycle. Thus, the RCAV will experience a duty cycle of 15 ms of its transmission time, then 1 ms+2×Dᵣᵤ/C of silence, then 3 ms of receipt of transmission from the remote controller, then 1 ms−2×Dᵣᵤ/C of silence, then it will start to transmit again.

For a duty cycle that starts in time to the RCAV will transmit between to and t₀+15 ms, will expect silence between t₀+15 ms and t₀+16 ms+2×Dᵣᵤ/C, and then will expect to receive the transmission from the remote controller exactly between t₀+16 ms+2×Dᵣᵤ/C and t₀+19 ms+2×Dᵣᵤ/C. It will start transmitting its next packet on t₀+20 ms.

This requires the remote controller to just transmit in a fixed delay of 1 ms after it has completed the reception of the packet transmitted by the RCAV, regardless of the distance between them. Taking into consideration the propagation delay, it will receive the packet from the RCAV only Dᵣᵤ/C seconds after the RCAV has started its transmission.

Hence, the remote controller will experience a duty cycle which is different than what the RCAV will experience: it will receive the transmission from the RCAV between t₀+Dᵣᵤ/C and t₀+15 ms+Dᵣᵤ/C, then silence for 1 ms, then it will transmit for 3 ms between t₀+16 ms+Dᵣᵤ/C and t₀+19 ms+Dᵣᵤ/C, then silence again for 1 ms between t₀+19 ms+Dᵣᵤ/C and t₀+20 ms+Dᵣᵤ/C until it starts receiving the next packet from the RCAV.

The silence periods that the remote controller is experiencing is again shorter between the RCAV packet and the remote controller packet and longer between the remote controller packet and the next RCAV packet compared to the silence periods the RCAV is experiencing.

As the RCAV and the remote controller may constantly move, the distance Dₛᵤ may change all the time (again, Dᵣᵤ(t) will denote the distance in time t, and the propagation time will be Dᵣᵤ(t)/C accordingly), and the delay in reception of the packet transmitted by the remote controller will vary accordingly. Since Dᵣᵤ is typically measured in kilometers and C is the atmosphere speed of light, Dᵣᵤ(t)/C will be measured in us (approximately 3 μs/km) and the delay the RCAV will have to expect will be approximately 6 μs per kilometer of distance between the RCAV and the remote controller.

The tolerance T will typically also be in the order of magnitude of a few μs. Hence the importance of the adjustment of the time of transmission according to the distance Dᵣᵤ(t).

Both of these schemes above can also be done by the RCVA gauging the remote controller according to its desired response, rather than doing calculations according to distance. Meaning, in case the RCVA needs the communication from the remote controller to be received earlier or later than it was received, it can notify the remote controller to change its timing as part of the information it transmits in its packets. This can keep on happening dynamically and continuously.

Some of the features in these examples assume that the RCAV is the master in the communication protocol. Obviously, parallel examples can be given where the remote controller is the master.

An intervention by the system in the communication can cause several distinct effects. We will discuss several of them here:
Disruption of reception of packets by transmitting an intervening signal
   i. Disruption type 1—intervening signal is transmitted in the frequency the RCVA is expecting the remote controller to transmit, over essentially all of the expected time of reception.
   ii. Disruption type 2—intervening signal is through a very short transmission on each of the possible frequencies the remote controller may be transmitting in, all of these short transmissions are made during the allotted time slot for the transmission of the packets by the remote controller (see, for example, patent IL260726).
Takeover/override-intervening signal is a legitimate remote controller packet which is received by the RCVA in higher power than the packet from the remote controller is received. Another variation is to transmit it so that it is received by the RCAV very shortly prior to the reception of the packet sent by the remote controller (but within the tolerance window T). The RCAV may then lock and start parsing the packet in the intervening signal and ignore the packet transmitted by the remote controller when it arrives.
Other types of disruptive packets (e.g. per patent application IL283154) that may cause the RCAV or one of its components to malfunction or act differently than what was intended and through that cause a disruption to the RCAV operation. The types of packets relevant to the current invention are those which intervene with the communication channel between the RCAV and the remote controller.
Combination of disruption and take over-a disruption of either type plus a legitimate remote controller packet that is transmitted in a different frequency or timing. There are some protocols that will direct the RCAV to search for alternative remote controller signals in case it loses the original signal (e.g. a fail-safe action in case the expected channels are suddenly noisy). In these cases such methods can cause the RCAV to disconnect from its remote controller, search for such an alternative, find the alternative signal transmitted by the take-over system, and lock on it, which may complete a take-over process.

Various examples are provided below.

The location of the three parties-system, RCAV, remote controller is accurately known. In this case the three distances Dₛᵤ, Dᵣᵤ, and Dₛᵣ are known. The response depends on the desired effect, and the type of response inbred in the protocol for the changing distance between the RCVA and the remote controller.

An intervention by a third party could be complicated, as any such intervention would not be effective if the timing the parties receive its communication does not match the expected timing.

The timing requirements might be in a resolution of microseconds, a resolution where relevant distances of RCVA flight (few km) can influence significantly. In case the locations of the three parties is known (e.g. when RCVAs transmit their exact GPS coordinates and the remote controller exact GPS coordinates as is required by the recent RID regulation issued by the US FAA), a method for adjusting the timing of transmission of intervening communication dynamically such that the intervened party will receive the communication in a timing that is controlled by the third party will be helpful. This can be applicable both for jamming or for overriding communication.

In the case of jamming, this invention can help save communication time and the resulting environmental disturbances, waste of power, and system heating.

When applying, for example, a method for inferring in time-division duplex communication (as illustrated, for example in U.S. Pat. No. 10,728,906 which is incorporated herein by reference) the timing accuracy, even in the resolution of μs, is important to make sure we do disrupt all the possible transmission frequencies the remote controller may use, as the transmissions are very short and sometimes need to hit a specific symbol that lasts about 50-200 μs over 40 frequencies.

In the case of sending a takeover packet (of all sorts), the timing accuracy is important because the RCVA may ignore the attempted communication in case the timing it is received is beyond the tolerance level the RCVA has for this reception, typically measured in μs, and in case the intervention method requires that the RCVA will receive the intervening packet within the tolerance T and before it receives the packet from the remote controller, the accuracy level is even more important.

As a further complication, if a RCVA travels a distance of even as little as 150 meters, which it can do in 9 seconds in 60 km/hr speed, the timing compensation can shift in one microsecond, which means that in case a few seconds have passed since the last GPS location received from the RCVA, there may be a need to estimate the RCVA location also according to its last recorded speed and direction, according to its track, and according to its behavior while it was tracked.

The intervening system needs to take into account all the considerations described and additional such considerations when it determines the timing of its transmissions. It then transmits in a timing that the receiving node (e.g. RCAV) will receive it in the timing needed to cause the desired effect. If we take as examples the two types of duty cycles described above, this will mean the following: Tg is the time difference between a start of the other RCU transmission time window and a start of a preceding target RCU transmission time window.

For the case of a fixed gap from the beginning or ending of the transmission of the packet from the RCAV to the reception by the RCAV of response from the remote controller: taking the same numbers discussed into consideration, if a certain transmission cycle starts at a certain time t, then
For a disruption of reception of packets by transmitting an intervening signal (either of type 1 or type 2), the transmission should be received by the RCAV in time t+16 ms. (In general t+Tg) Considering the propagation delay, the system will have to transmit the disruptive packet at time t+16 ms−Dₛᵤ(t)/C. In general t+T_{G}−Dₛᵤ(t)/C.
For a takeover/override, in case the method uses an alternative packet that is transmitted so that it would be received by the RCAV in higher power than it receives the signal from the remote controller, the timing should be similar to the case of the disruption signal above, which is, t+16 ms−Dₛᵤ(t)/C. In case the method is to cause the alternative packet to be received before the packet from the remote controller but within the tolerance window, the timing would also take that into account and can use the timing t+16 ms−Dₛᵤ(t)/C−T/2 (where T/2 is an example for a time shift that would stay within the tolerance window of T)−in general t+T_{G}−Dₛᵤ(t)/C−T/2. It should be noted that even if no timing compensation is needed because of the distances, the timing compensation of T/2 (or similar compensation that causes the same effect) can still be used as a method for causing the RCAV to process the packet sent by the take-over system.
Other types of disrupting packets will be able to use either timing compensation methods of the ones mentioned above, depending on the mechanism of disruption.
In the case of combination between disruption and take over, the disruptive packet will use the timing compensation as described above (t+16 ms−Dₛᵤ(t)/C)—in general t+T_{G}−Dₛᵤ(t)/C, and the alternative signal used to take over will either use the same timing compensation as described above (t+16 ms−Dₛᵤ(t)/C) for an alternative signal that is transmitted in a different frequency, or a different alternative timing that would be in an appropriate shift from the timing t+16 ms−Dₛᵤ(t)/C that matches the remote controller's timing.

For the case of a fixed gap from the beginning or ending of the reception of the packet from the RCAV to the transmission of response from the remote controller: taking the same numbers discussed into consideration, if a certain transmission cycle starts at a certain time t, then
For a disruption of reception of packets by transmitting an intervening signal (either of type 1 or type 2), the transmission should be received by the RCAV in time t+16 ms+2×Dᵣᵤ(t)/C. Considering the propagation delay, the system will have to transmit the disruptive packet at time t+16 ms+2×Dᵣᵤ(t)/C−Dₛᵤ(t)/C. In general—t+T_{G}+2×Dᵣᵤ(t)/C−Dₛᵤ(t)/C.
For a takeover/override, in case the method uses an alternative packet that is transmitted so that it would be received by the RCAV in higher power than it receives the signal from the remote controller, the timing should be similar to the case of the disruption signal above, which is, t+16 ms+2−Dᵣᵤ(t)/C−Dₛᵤ(t)/C (In general—t+T_{G}+2×Dᵣᵤ(t)/C−Dₛᵤ(t)/C). In case the method is to cause the alternative packet to be received before the packet from the remote controller but within the tolerance window, the timing would also take that into account and can use the timing t+16 ms+2×Dᵣᵤ(t)/C−Dₛᵤ(t)/C−T/2 (where T/2 is an example for a time shift that would stay within the tolerance window of T)—In general—t+T_{G}+2×Dᵣᵤ(t)/C−Dₛᵤ(t)/C−T/2. It should be noted that even if no timing compensation is needed because of the distances, the timing compensation of T/2 (or similar compensation that causes the same effect) can still be used as a method for causing the RCAV to process the packet sent by the take-over system.
Other types of disrupting packets will be able to use either timing compensation methods of the ones mentioned above, depending on the mechanism of disruption.
In the case of combination between disruption and take over, the disruptive packet will use the timing compensation as described above t+TG+2×Dru(t)/C−Dₛᵤ(t)/C (for example—t+16ms+2×Dᵣᵤ(t)/C−Dₛᵤ(t)/C), and the alternative signal used to take over will either use the same timing compensation as described above (for example—t+16 ms+2×Dᵣᵤ(t)/C−Dₛᵤ(t)/C) for an alternative signal that is transmitted in a different frequency, or a different alternative timing that would be in an appropriate shift from the timing (for example t+16 ms+2×Dᵣᵤ(t)/C−Dₛᵤ(t)/C) that matches the remote controller's timing.

In case the RCAV (or the master in the communication) gauges the required delay from the other node, and the system is aware of such gauging (e.g. by receiving and analyzing the packets with the gauging data), it should adjust the timing so that its packet will be received by the RCAV at the same timing (or with a slight shift before as is detailed above) as the packet of the remote controller. Considering the propagation delay, if the remote controller is required to transmit at a time t, then its packet will be received by the RCAV at time t+Dᵣᵤ(t)/C, and hence the system should transmit its packet at time t+Dᵣᵤ(t)/C−Dₛᵤ(t)/C.

A general note for all the timing compensations above is that the time t of the start of transmission by the RCAV should also be assessed by the disrupting system. Considering the propagation delay, that packet will be received by the disrupting system at time t′=t+Dₛᵤ(t)/C and hence, the system should shift the time of RCAV transmission it uses when determining the time of system transmission by another Dₛᵤ(t)/C (e.g. in case it should transmit in time t+16 ms+2×Dᵣᵤ(t)/C−Dₛᵤ(t)/C (In general—t+T_{G}+2×Dᵣᵤ(t)/C−Dₛᵤ(t)/C), it will use t′+16 ms+2×Dᵣᵤ(t)/C−2×Dₛᵤ (t)/C (In general—t′+T_{G}+2×Dᵣᵤ(t)/C−2×Dₛᵤ (t)/C) which is identical, but since the system is aware of the time it actually receives the packet, which is t′ rather than t, this may be a more convenient way to calculate the timing of transmission).

All the methods for timing compensation above were assuming a consistent or accurate enough knowledge of the GPS location of the RCAV, the remote controller, and the system-meaning, a knowledge of the functions Dᵣᵤ(t), Dₛᵤ(t), Dₛᵣ(t). In case either of the functions that are relevant for the calculation of the timing compensation that is needed is not known for the current time t, but it was known for some points of time in the past, the timing compensation can use an extrapolated distance, by assessing an extrapolated location of the nodes.

Extrapolating a GPS location should take into account the known past GPS locations and their timing, and the type of node that is being assessed. For instance, assessing the GPS location of a remote controller can take into account the typical movement of a remote controller-ground based, no significant rapid change of altitude. It can also take into account the behavior of that node that was recorded by the system during the current session, or by using typical past behavior of this node, or of other such nodes. In case an update on the GPS location becomes available, the methods of assessment can use the error they have from their assessment in order to better assess the GPS location of this node or other such nodes next time this is required.

In case either or both of the GPS locations of the nodes are unknown, the timing compensation cannot be calculated properly. Instead, the system may try different possible timing compensations until it succeeds to cause the effect it tried to cause. Knowing the required timing compensation (the attempted one that worked) can in turn help the system assess the distance to the node.

The system may execute one or more disruptive iterations of (a) determining the timing of the transmission of the disruptive signal, and (b) transmitting the disruptive signal using one or more assumptions regarding the distances (for example—two or more of (Dₛᵤ(t), Dᵣᵤ(t), Dₛᵣ(t)). The system may also monitor the response of the RCVA to the one or more disruptive iterations and may maintain the assumptions or update the assumptions based on the outcome of the one or more disruptive iterations.

For example—if a response of the RCVA indicates that the disruption was successful, the system will keep using the assumed distances for its disruption.

If the disruption was not successful, the system may changes at least one or more of the assumptions and perform one or more disruption iterations—for example by increasing or reducing one or more of the timing compensation (based on the assumptions) it uses. For instance, the system may wait for two seconds, and if the disruption iterations during these two seconds were not successful-delay its transmissions with some delta (e.g. 3 microseconds-or any number of microseconds) and wait another two seconds, then add another delta (of the same value as the previous delta—or at another value) and repeat the disruptive iterations-until succeeding in the disruptive iterations—and finding a delta that works.

The system can then go back to the original timing compensation it used and start its transmissions a delta earlier and try, and if not successful reduce the transmission timing by another delta and try again, and so on. The system may continue this cycle of changing the delta between delta values boundaries until the system performs a successful disruptive iteration. The cycle can also use different patterns (e.g—change the timing of transmission by deltas such as +3, −3, +6, −6 microseconds, and the like) during its disruptive iterations.

Once a disruptive iteration succeeds, the system will lock on the timing compensation that worked, and can continue to disrupt, and may start the cycle (of checking timings based on distance assumptions) again in case the disruption breaks, which would indicate that the nodes have moved and that the compensation is again inaccurate.

The system may determine whether the disruption attempt was successful either by receiving signals that indicate so from the RCVA or its remote controller, or by manual commands that an operator gives following his surveillance of the RCVA directly (for example, by use of binoculars or camera) or through other means.

The above description took into account that the disrupted node is the RCAV. In case it is the remote controller, the appropriate distances should be used in the calculation. This compensation can also be used in case there are multiple nodes in the communication, where the distances used in the calculation in this case are the appropriate distances between the two specific nodes that the disruption is targeting.

The same timing compensation can also be used for additional tasks. A notable example is that if the system needs to intercept a message sent by one of the nodes, and due to some consideration, it needs to know the expected timing of such message (e.g. in case the detectors will work better if they have an accurate or approximated timing for the detection), it can calculate that expected timing using the same timing compensation methods. For instance, if the remote controller is expected to transmit at time t, the expected time for reception is t+Dₛᵣ(t)/C, and if t is calculated through the methods mentioned above (using the system reception time of the packet transmitted by the RCAV), then the time shift Dₛᵣ(t)/C can be added to assess the expected timing of reception of the packet transmitted by the remote controller.

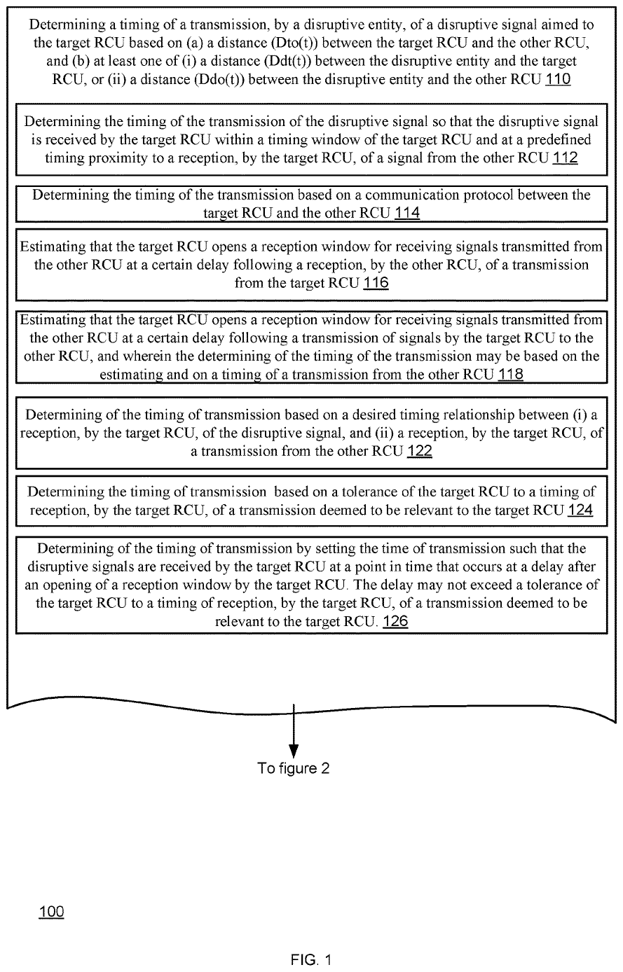

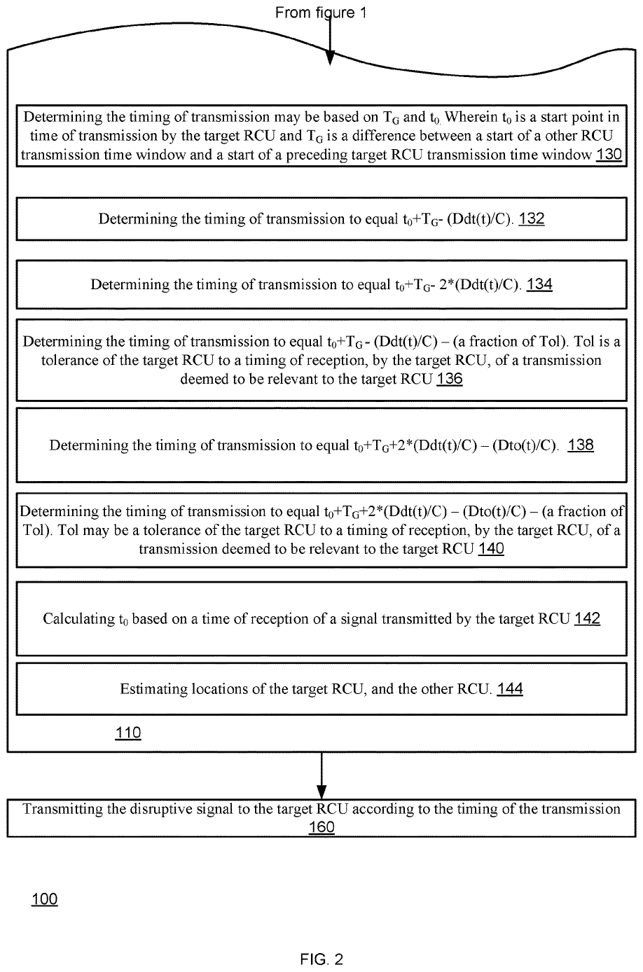

FIGS. 1 and 2 illustrate a computerized method 100 for disrupting a time division multiplex communication between a target remotely-controlled aerial vehicle related communication unit (RCU) and another RCU.

Method 100 may start by step 110 of determining a timing of a transmission, by a disruptive entity, of a disruptive signal aimed to the target RCU based on (a) a distance (Dto(t)) between the target RCU and the other RCU, and (b) at least one of (i) a distance (Ddt(t)) between the disruptive entity and the target RCU, or (ii) a distance (Ddo(t)) between the disruptive entity and the other RCU.

Step 110 may be followed by step 160 of transmitting the disruptive signal to the target RCU according to the timing of the transmission.

Step 110 may include step 112 of determining the timing of the transmission of the disruptive signal so that the disruptive signal is received by the target RCU within a timing window of the target RCU and at a predefined timing proximity to a reception, by the target RCU, of a signal from the other RCU.

The timing proximity may be fulfilled when the disruptive signal is started to be received by the target RCU within the reception window of the target RCU but before a start of a reception, by the target RCU, of the signal from the other RCU.

The timing proximity may be fulfilled when the disruptive signal is received by the target RCU within the reception window of the target RCU and in parallel to a reception, by the target RCU, of the signal from the other RCU.

Step 110 may be include step 114 of determining the timing of the transmission based on a communication protocol between the target RCU and the other RCU.

The target RCU may be a remotely-controlled aerial vehicle or a remote controller of a remotely-controlled aerial vehicle.

Step 110 may include step 116 of estimating that the target RCU opens a reception window for receiving signals transmitted from the other RCU at a certain delay following a reception, by the other RCU, of a transmission from the target RCU.

Step 110 may include step 118 of estimating that the target RCU opens a reception window for receiving signals transmitted from the other RCU at a certain delay following a transmission of signals by the target RCU to the other RCU, and wherein the determining of the timing of the transmission may be based on the estimating and on a timing of a transmission from the other RCU.

Step 110 may include step 122 of determining of the timing of transmission based on a desired timing relationship between (i) a reception, by the target RCU, of the disruptive signal, and (ii) a reception, by the target RCU, of a transmission from the other RCU.

The desired timing relationship may require that the reception, by the target RCU, of the disruptive signal, precedes the reception, by the target RCU, of a transmission from the other RCU.

Step 110 may include step 124 of determining the timing of transmission based on a tolerance of the target RCU to a timing of reception, by the target RCU, of a transmission deemed to be relevant to the target RCU.

Step 110 may include step 126 of determining of the timing of transmission by setting the time of transmission such that the disruptive signals are received by the target RCU at a point in time that occurs at a delay after an opening of a reception window by the target RCU. The delay may not exceed a tolerance of the target RCU to a timing of reception, by the target RCU, of a transmission deemed to be relevant to the target RCU.

Step 110 may include step 130 of determining the timing of transmission is also based on T_{G}and to. Wherein to is a start point in time of transmission by the target RCU and T_{G} is a difference between a start of a other RCU transmission time window and a start of a preceding target RCU transmission time window.

Step 110 may include step 132 of determining the timing of transmission to be equal to t₀+T_{G}−(D_{dt}(t)/C), wherein C is the speed of light.

Step 110 may include step 134 of determining the timing of transmission to be equal to t₀+T_{G}−2−(D_{dt}(t)/C), wherein C is the speed of light.

Step 110 may include step 136 of determining the timing of transmission to be equal to t₀+T_{G}−(D_{dt}(t)/C)—(a fraction of Tol); and wherein C is the speed of light, and Tol may be a tolerance of the target RCU to a timing of reception, by the target RCU, of a transmission deemed to be relevant to the target RCU.

Step 110 may include step 138 of determining the timing of transmission to be equal to t₀+T_{G}+2×(D_{dt}(t)/C)−(Dₜₒ(t)/C), wherein C is the speed of light.

Step 110 may include step 140 of determining the timing of transmission to be equal to t₀+T_{G}+2×(D_{dt}/C)−(Dₜₒ/C)−(a fraction of Tol), wherein C is the speed of light, and Tol may be a tolerance of the target RCU to a timing of reception, by the target RCU, of a transmission deemed to be relevant to the target RCU.

Step 110 may include step 142 of calculating to based on a time of reception of a signal transmitted by the target RCU.

Step 110 may include step 144 of estimating locations of the target RCU, and the other RCU.

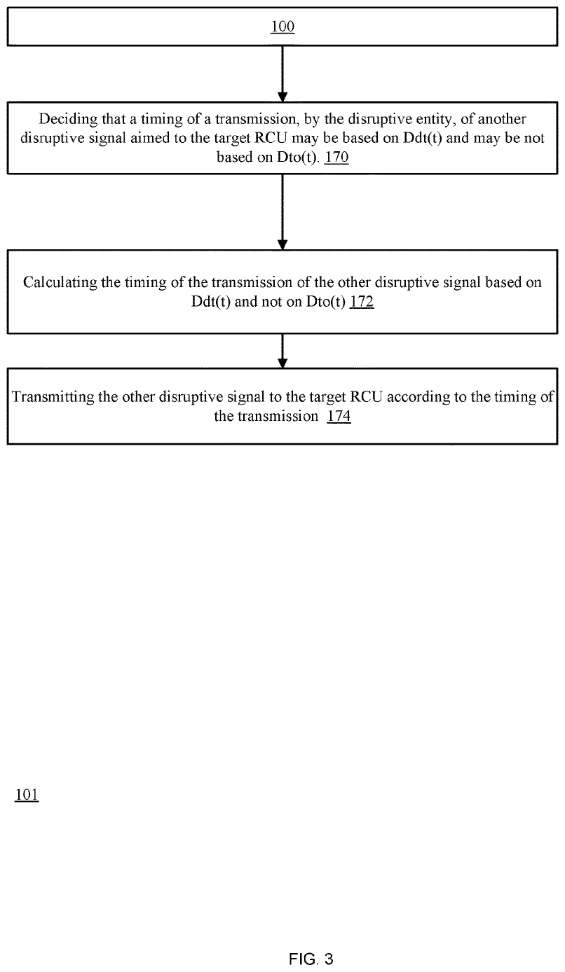

FIG. 3 illustrates an example of method 101.

Method 101 may start by one or more iterations of method 100. Thus executing one or more iterations of step 110 followed by step 160.

The one or more iterations may be followed by step 170 of deciding that a timing of a transmission, by the disruptive entity, of another disruptive signal aimed to the target RCU may be based on D_{dt}(t) and may be not based on Dto(t).

Step 170 may be followed by step 172 of calculating the timing of the transmission of the other disruptive signal based on D_{dt}(t) and not on Dₜₒ(t).

Step 172 may be followed by step 174 of transmitting the other disruptive signal to the target RCU according to the timing of the transmission.

One or more iterations of steps 170, 172 and 174 may be followed by determining to execute one or more iterations of method 100—and executing the one or more iterations of method 100.

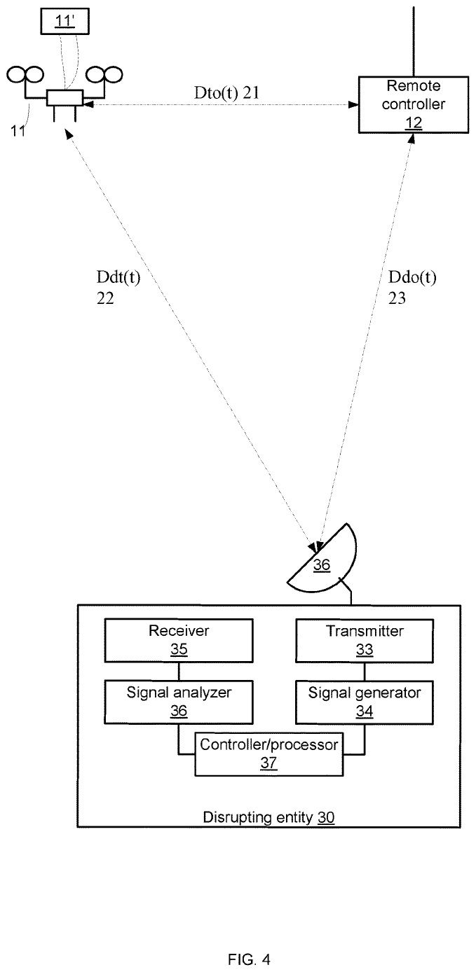

FIG. 4 provides an example of target RCU 11′ of a RCVA 11, another RCU 12 which is a remote controller 12, disruptive entity 30, Dₜₒ(t) 21, D_{dt}(t) 22 and D_{do}(t) 23. The disruptive entity 30 is illustrated as including antenna 36, receiver 35, signal analyzer 36, controller/processor 37, transmitter 33 and signal generator 37.

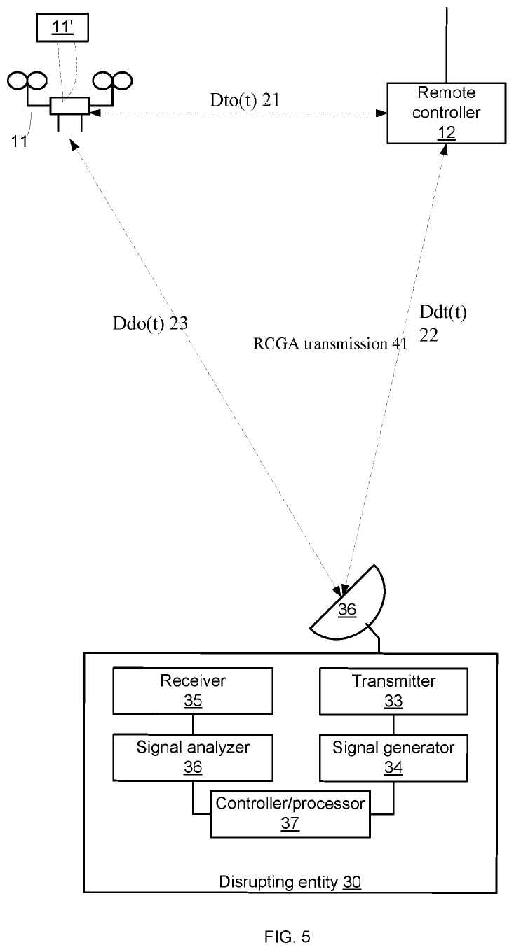

FIG. 5 provides a second example of target RCU which is the remote controller 12, another RCU 11′ which belongs to RCVA 11, disruptive entity 30, Dₜₒ(t) 21, D_{dt}(t) 22 and D_{do}(t) 23.

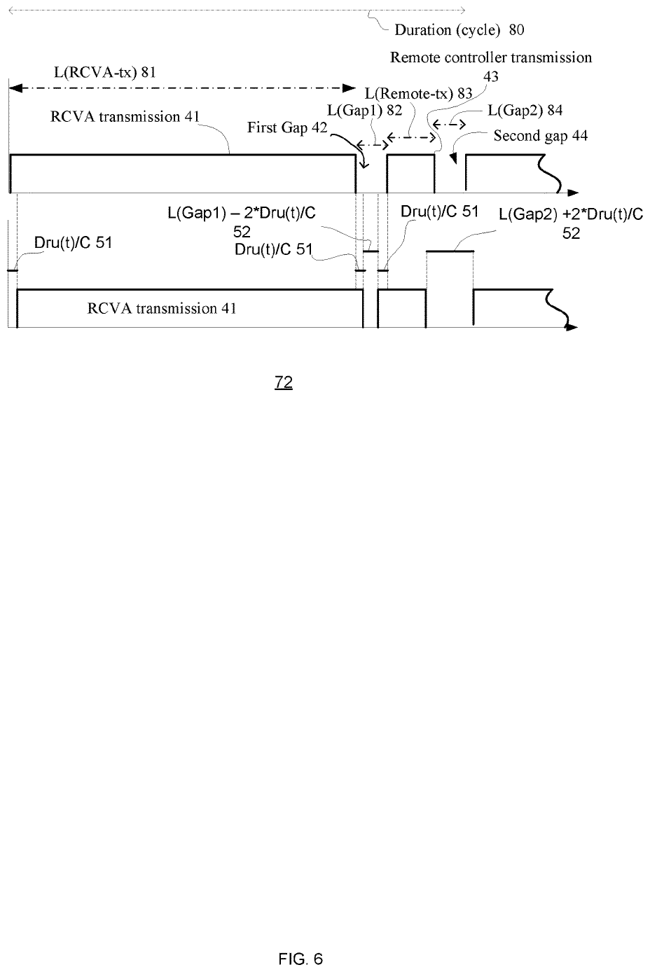

FIG. 6 illustrates timing diagrams 71 and 72.

First timing diagram 71 illustrates signals at the time line of the RCVA and illustrates a cycle having a duration 80, the cycle starts by RCVA transmission 41 (length denoted L(RCVA-tx) 81), followed by first gap 42 (length L(Gap 1) 82, a remote controller transmission 43 (length L(Remote-tx) 83), second gap 44 (length L(Gap2) 84).

Second timing diagram 72 illustrates signals at the time line of the remote controller. It can be seen that the RCVA transmission is received by the remote controller at a delay of Dᵣᵤ(t)/C (delay denoted 51), and that a first gap (as viewed by the remote controller has a duration of L(Gap1)−2×Dᵣᵤ(t)/C, the remote controller transmission precedes the remote controller transmission (as viewed by the RCVA by Dᵣᵤ(t)/C ), and the second time gap as viewed by the remote controller has a duration of L(Gap2)+2×Dᵣᵤ(t)/C.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

In the foregoing specification, the invention has been described with reference to specific examples of embodiments of the invention. It will, however, be evident that various modifications and changes may be made therein without departing from the broader spirit and scope of the invention as set forth in the appended claims.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub-combination.

It will be appreciated by persons skilled in the art that the embodiments of the disclosure are not limited by what has been particularly shown and described hereinabove. Rather the scope of the embodiments of the disclosure is defined by the appended claims and equivalents thereof.

We claim

1. A computerized method for disrupting a time division multiplex communication between a target remotely-controlled aerial vehicle related communication unit (RCU) and another RCU, the method comprises:
determining a timing of a transmission, by a disruptive entity, of a disruptive signal aimed to the target RCU based on (a) a distance (Dto(t)) between the target RCU and the other RCU, and (b) at least one of (i) a distance (Ddt(t)) between the disruptive entity and the target RCU, or (ii) a distance (Ddo(t)) between the disruptive entity and the other RCU; and
transmitting the disruptive signal to the target RCU according to the timing of the transmission.

2. The computerized method according to claim 1 comprising the timing of the transmission of the disruptive signal so that the disruptive signal is received by the target RCU within a timing window of the target RCU and at a predefined timing proximity to a reception, by the target RCU, of a signal from the other RCU.

3. The computerized method according to claim 2 wherein the timing proximity if fulfilled when the disruptive signal is started to be received by the target RCU within the reception window of the target RCU but before a start of a reception, by the target RCU, of the signal from the other RCU.

4. The computerized method according to claim 2 wherein the timing proximity if fulfilled when the disruptive signal is received by the target RCU within the reception window of the target RCU and in parallel to a reception, by the target RCU, of the signal from the other RCU.

5. The computerized method according to claim 1 wherein the determining of the timing of the transmission is made based on a communication protocol between the target RCU and the other RCU.

6. The computerized method according to claim 1, wherein the target RCU is a remotely-controlled aerial vehicle.

7. The computerized method according to claim 1, wherein the target RCU is a remote controller of a remotely-controlled aerial vehicle.

8. The computerized method according to claim 1, wherein the determining of the timing of transmission comprises estimating that the target RCU opens a reception window for receiving signals transmitted from the other RCU at a certain delay following a reception, by the other RCU, of a transmission from the target RCU.

9. The computerized method according to claim 1, wherein the determining of the timing of the transmission comprises estimating that the target RCU opens a reception window for receiving signals transmitted from the other RCU at a certain delay following a transmission of signals by the target RCU to the other RCU, and wherein the determining of the timing of the transmission is based on a timing of a transmission from the other RCU.

10. The computerized method according to claim 1 wherein the determining of the timing of transmission is also based on a desired timing relationship between (i) a reception, by the target RCU, of the disruptive signal, and (ii) a reception, by the target RCU, of a transmission from the other RCU.

11. The computerized method according to claim 10 wherein the desired timing relationship requires that the reception, by the target RCU, of the disruptive signal, precedes the reception, by the target RCU, of a transmission from the other RCU.

12. The computerized method according to claim 10 wherein the determining of the timing of transmission is also based on a tolerance of the target RCU to a timing of reception, by the target RCU, of a transmission deemed to be relevant to the target RCU.

13. The computerized method according to claim 10 wherein the determining of the timing of transmission comprises setting the time of transmission such that the disruptive signals is received by the target RCU at a point in time that occurs at a delay after an opening of a reception window by the target RCU, wherein the delay does not exceed a tolerance of the target RCU to a timing of reception, by the target RCU, of a transmission deemed to be relevant to the target RCU.

14. The computerized method according to claim 1 wherein the determining of the timing of transmission is also based on a tolerance of the target RCU to a timing of reception, by the target RCU, of a transmission deemed to be relevant to the target RCU.

15. The computerized method according to claim 1 comprising:
deciding that a timing of a transmission, by the disruptive entity, of another disruptive signal aimed to the target RCU is based on Ddt(t) and is not based on Dto(t);
calculating the timing of the transmission of the other disruptive signal based transmitting the other disruptive signal to the target RCU according to the timing of the transmission.

16. The computerized method according to claim 1 comprising estimating locations of the target RCU, and the other RCU.

17. The computerized method according to claim 1 comprising determining the timing of transmission is also based on Tg and t₀; wherein t₀ is a start point in time of transmission by the target RCU, and Tg is difference between a start of a other RCU transmission time window and a start of a preceding target RCU transmission time window.

18. The computerized method according to claim 17 comprising determining the timing of transmission of the disruptive signal to be equal to t₀+T_{G}−(D_{dt}(t)/C), wherein C is the speed of light.

19. The computerized method according to claim 17 comprising determining the timing of transmission of the disruptive signal to be equal to t₀+T_{G}−2×(D_{dt}(t)/C), wherein C is the speed of light.

20. The computerized method according to claim 17 comprising determining the timing of transmission of the disruptive signal to be equal to t₀+T_{G}−(D_{dt}(t)/C)−(a fraction of Tol); and wherein C is the speed of light, and Tol is a tolerance of the target RCU to a timing of reception, by the target RCU, of a transmission deemed to be relevant to the target RCU.

21. The computerized method according to claim 17 comprising determining the timing of transmission of the disruptive signal to be equal to t₀+T_{G}+2×(D_{dt}(t)/C)−(Dₜₒ(t)/C), wherein C is the speed of light.

22. The computerized method according to claim 17 comprising determining the timing of transmission of the disruptive signal to be equal to t₀+T_{G}+2×(D_{dt}(t)/C)−(Dₜₒ(t)/C)−(a fraction of Tol), wherein C is the speed of light, and Tol is a tolerance of the target RCU to a timing of reception, by the target RCU, of a transmission deemed to be relevant to the target RCU.

23. The computerized method according to claim 17 comprising calculating to based on a time of reception of a signal transmitted by the target RCU, and on D_{dt}(t).

24. A non-transitory computer readable medium for time division multiplex communication between a target remotely-controlled aerial vehicle related communication unit (RCU) and another RCU, the non-transitory computer readable medium that stores instructions for:
determining a timing of a transmission, by a disruptive entity, of a disruptive signal aimed to the target RCU based on (a) a distance (Dto(t)) between the target RCU and the other RCU, and (b) at least one of (i) a distance (D_{dt}(t)) between the disruptive entity and the target RCU, or (ii) a distance (Ddo(t)) between the disruptive entity and the other RCU; and
transmitting the disruptive signal to the target RCU according to the timing of the transmission.

25. A system for time division multiplex communication between a target remotely-controlled aerial vehicle related communication unit (RCU) and another RCU, the system comprising:
a controller that is configured to determine a timing of a transmission of a disruptive signal aimed to the target RCU based on (a) a distance (Dto(t)) between the target RCU and the other RCU, and (b) at least one of (i) a distance (Ddt(t)) between the disruptive entity and the target RCU, or (ii) a distance (Ddo(t)) between the disruptive entity and the other RCU; and
a transmitter that is configured to transmit the disruptive signal to the target RCU according to the timing of the transmission.
